(19) United States
(12) Patent Application Publication
(10) Pub. No.: US 2013/0002872 A1
(43) Pub. Date: Jan. 3, 2013

(54) ADAPTABLE NIGHT VISION SYSTEM

(76) Inventors: STEPHEN D. FANTONE, LYNNFIELD, MA (US); BRADLEY S. FAECHER, SUDBURY, MA (US)

(21) Appl. No.: 13/534,002

(22) Filed: Jun. 27, 2012

Related U.S. Application Data
(60) Provisional application No. 61/503,701, filed on Jul. 1, 2011.

(51) Int. Cl. H04N 7/18

(52) U.S. Cl. 348/148; 348/E07.085

(57) ABSTRACT

An adaptable night vision system comprises a series of individual night vision function providing modules that are adapted to selectively releasably interface with others in the system so that, when mated, each combination provides a product whose features are not available with the individual modules themselves. Such modules comprise a combined camera and illumination module, separate illumination and camera modules, a display module, auxiliary optics module for observing display images when close to the naked eye, and communication link modules. The modules are adapted with common interfaces to easily combine with base units to form a head mount night vision device, a hand held night vision device, a remote camera device, a toy vehicle, and a hand held vehicle controller.

### CROSS REFERENCE TO RELATED APPLICATION

This invention claims the benefit of priority from U.S. Provisional Patent Application No. 61/503,701 filed on Jul. 1, 2011 in the name of Stephen D. Fantone, et al. with the title. ADAPTABLE NIGHT VISION SYSTEM, the entire contents of which are incorporated herein by reference.

### FIELD OF THE INVENTION

This invention relates generally to night vision apparatus and more specifically to a system employing adaptable modules that may be selectively coupled with others via common interfaces to provide products that are useful as toys, novelty items, or for general observation of nearby or remote surroundings at night.

### BACKGROUND OF THE INVENTION

Apparatus that augment a user's ability to visualize the surrounding environment under conditions of darkness or low illumination are generally referred to as night vision devices. Previous devices targeted towards consumer markets have typically comprised a low cost camera and illumination means that are integrally mounted with a display unit on a head mount with the camera and illumination parts suspended or held in front of the user's eye (See, for example, U.S. Pat. No. 7,064,327 by Fantone and Orband). The technology described in the '327 patent has been implemented in consumer products utilizing CMOS imagers in the camera, infrared LEDs for illumination, and low cost LCDs in the display module. With such systems, it should be noted that, in some cases, there may be sufficient ambient light in the scene such that the camera, if sufficiently sensitive, can generate adequate images without the use of additional illumination beyond that of the ambient environment.

However, existing commercial units have limitations that prevent them from achieving additional functionality. Presently available commercial units are directional, i.e., the field that can be viewed by the device is boresighted with the direction the user is facing, and cameras cannot be operated remotely from the user. Moreover, there is a direct mechanical connection between the camera and the display preventing either from being detached from the other.

Consequently, there is a need for more adaptable night vision apparatus, and it is a principal object to provide such apparatus.

It is another object of the present invention to provide an adaptable night vision system by which individual function providing modules may be readily and easily combined with others in the system to provide products having functionality not available with the individual modules acting alone.

It is another object of the invention to provide inexpensive night vision apparatus which can be used safely by the general public without the need for specialized training. Desirably, such apparatus should be compact, have sufficiently low power requirements that it can be supplied by batteries, and produce images based upon visual properties of the environment such that the images can be easily interpreted by even inexperienced operators.

It is a further object of this invention to provide such apparatus which does not emit substantial amounts of visible radiation.

It is yet another object of this invention to provide such apparatus by which head-worn, hand-held, vehicular, and remote versions can be constructed by easy interchange of modules provided with suitable interfaces.

Other objects of the invention will be apparent and will appear hereinafter in the following detailed description when read in connection with the drawings.

### SUMMARY OF THE INVENTION

An adaptable night vision system comprises a series of individual night vision function providing modules that are adapted to selectively releasably interface with others in the system so that, when mated, each combination provides a product whose features are not available with the individual modules themselves. Such modules comprise a combined camera and illumination module, separate illumination and camera modules, a display module, auxiliary optics module for observing display images when close to the naked eye, and communication link modules. The modules are adapted with common interfaces to easily combine with base units to form a head mount night vision device, a hand held night vision device, a remote camera device, a toy vehicle, and a hand held vehicle controller.

In an aspect of the invention, the camera and illumination module comprises a a solid state imager having an operating mode having substantial sensitivity to infrared radiation within its field of view and adapted to generate an image output signal representative of the subject matter that it observes and a radiation source to generate infrared radiation and to direct such radiation into the field of view of the solid state imager.

In another aspect of the invention, the display module is arranged to receive the image output signal from the solid state imager and to generate an image visible to a user.

In another aspect of the invention, the toy vehicle is selected from the group comprising remote controlled vehicles such as an RC car, boat, plane, and helicopter.

In yet another aspect of the invention the communication link module is present in at least one of said base modules and said night vision function providing modules and is selected from the group comprising direct wiring, a wireless link including Bluetooth®, analog radio frequency signals, digital radio signals, and an infrared optical link.

### BRIEF DESCRIPTION OF THE DRAWINGS

The structure and operation of the night vision modular system of the present invention, together with other objects and advantages thereof, may best be understood by reading the following detailed description in connection with the drawings in which unique reference numerals have been used throughout for each part and wherein:

FIGS. 1a and 1b diagrammatically illustrate a head mounted night vision system representing one possible combination of modules and base units;

FIGS. 2A and 2B diagrammatically illustrate via front and back elevational views, respectively, of a hand held configuration of night vision modules forming a hand held night vision device;

FIGS. 3A and 3B are diagrammatic perspectives showing a remotely controlled vehicle system that is another combination of night vision modules and base units;

FIG. 4 is a schematic block diagram view of the optical and image-generating components of the head-mounted unit shown in FIGS. 1a and 1b and illustrate the camera and display module used in conjunction with the auxiliary optical module; and

FIG. 5 is a block diagram showing the generation and display images signals components of the inventive modules; and

FIG. 6 is a graph showing the spectral response of the solid state imager and the spectra of the emissions from the light emitting diodes shown in FIG. 4 and elsewhere.

### DETAILED DESCRIPTION OF THE INVENTION

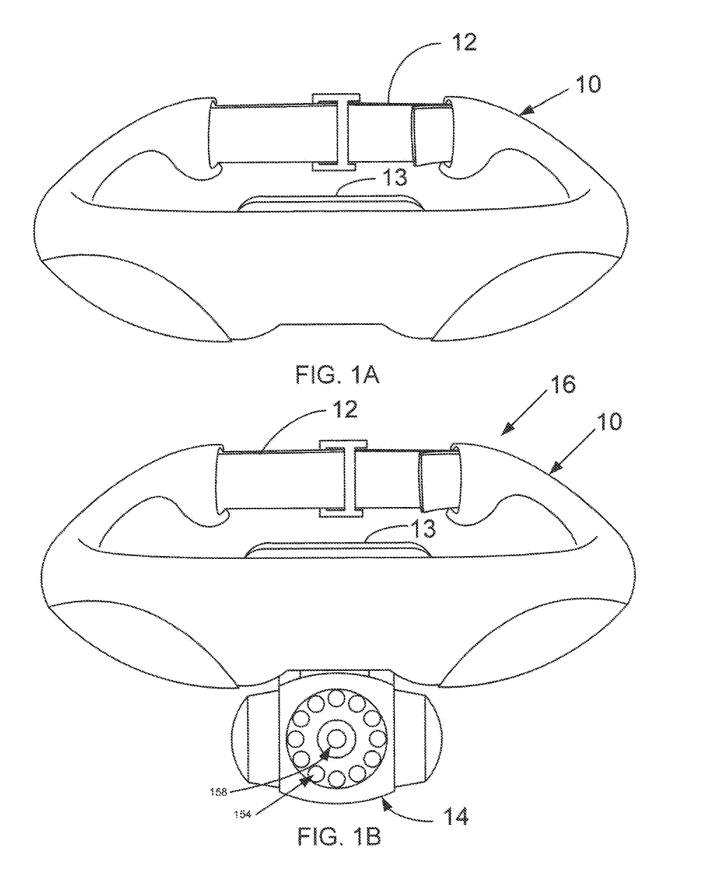

Referring now to FIGS. 1A and 1B, there is shown a head mount 10 provided with an elastic band 12 so that head mount 10 that may be worn by a user in the manner of a pair of goggles. As seen in FIG. 1B, head mount 10 of FIG. 1A has attached to it a night vision camera and illumination module 14 to form a night vision goggle system 16 that operates in a manner to be described.

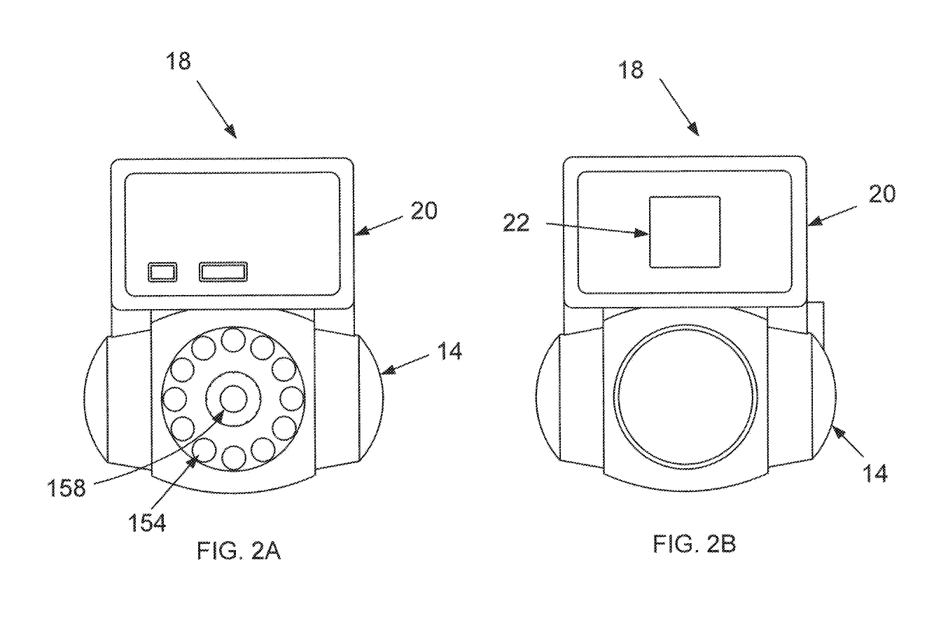

FIGS. 2A and 2B show front and back elevational views, respectively, of a hand held system 18 combining a night vision hand held base 20 having attached to it the camera and illumination module 14 and a display module 22. Images formed by the module 14 are directly viewable on display 22 with the unaided eye.

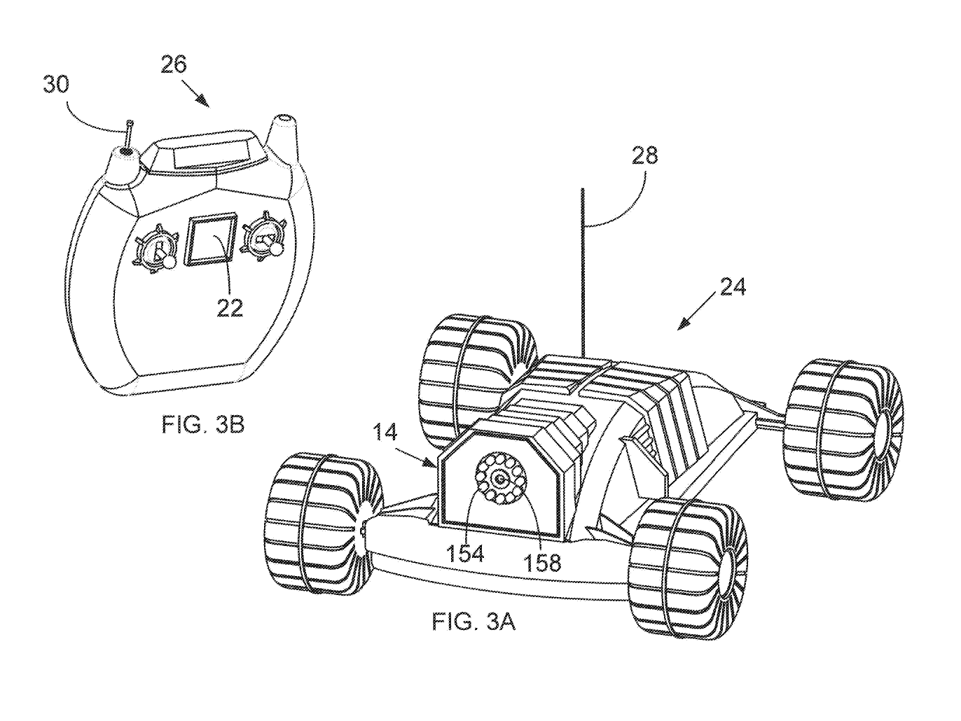

Referring now to FIGS. 3A and 3B, there is shown a remotely controlled toy car 24 that has attached to it a camera and illumination module 14 that operates under low ambient light conditions to generate and transmit a video signal to a remote controller 26 via an RF antenna system. The image transmitted to the controller 26 is visible via night vision display module 22. The car 24 is controlled in the usual manner so that it can be remotely moved while at the same time generating and transmitting video output to the display module 22.

The additional functionality for each combination is provided by allowing the camera and illumination module 14 and display module 22 to be physically disconnected from each other and to be independently placed and oriented in other configurations. Additionally, the docked modules can operate as one unit in a way described by the aforementioned '327 patent, but then the camera/illumination module 14 can be removed and directed or oriented as a unit separate from the display module 22.

When mechanically uncoupled, the camera/illumination module 14 and display module 22 may be separately powered, each with its own power source, typically batteries. When mechanically coupled, they may share the same power source.

The video signal from the camera and illumination module 14 can be conveyed to the display module 22 through a variety of methods including direct wiring, a wireless link such as Bluetooth®, analog radio frequency signals, digital radio signals, or an infrared optical link. A major advantage of this approach is that the unit can be operated as either a “docked” unit with direct mechanical coupling between the display module 22 and the camera and illumination module 14, or as physically separate units.

Thus the user, when operating the night vision system as head mounted system 16 combining camera and illumination module 14 and display module 22 can manually remove the camera and illumination module 14 from head mount 10 and reposition and point the camera and illumination module 14 in any direction. Also, the camera and illumination module 14 can be placed into a position or on an object remote to the user so that the user can surveil a scene remotely from a distance only limited by the range of the communication link, for example, a wireless link.

The various modules of the invention may be mechanically mated and disconnected from one another by well-known arrangements such as screw mounts, baynet mounts, spring loaded ball and detent schemes, keyed guide and lock mechanisms, or traditional fasteners.

If there is sufficient light, there may be no need for the illumination module to be activated to supply additional illumination to the scene. If a visible light detector is incorporated into the illumination system or if the camera is used (with the illumination system turned off) to measure the amount of ambient light, a determination can be made as to whether additional illumination is required and the output of the illumination source adjusted to add additional illumination. If additional illumination is required to view the scene, either infrared light and/or visible light can be activated. The advantage of using infrared light is that it will not be observed by individuals or animals that are in the immediate area of the illumination system.

Several immediate applications of this technology allowing separation of the display unit include placing the camera and illumination module on a bicycle, hunting weapon such as a handgun, rifle, or bow, placing the camera and illumination module 14 on the bow of a boat or motor craft or a remote control vehicle such as a RC car, boat, plane, or helicopter.

Also, the illumination source, described in more detail below, can be a separate unit from the camera thus allowing for the configuration of illumination units with different illumination capacities and spectral distributions—all visible output, all infrared output, and mixed output. When the anticipated use is in small rooms or hallways or basements, a low power illumination system may suffice. When the anticipated use is outside over a large area, illumination systems with higher power may be required and can be readily be accommodated.

Additional capabilities that can readily be added to the inventive systems include:
1) Incorporation of means to activate the illumination source from the head or hand mounted display. This can be done with a wireless link that would allow the user to remotely activate the source of illumination. By utilizing multiple light sources, the spectrum (IR and visible) and intensity level (total power of the light source) can be controlled, and
2) Docking the camera and illumination module 14, or separate camera and illumination modules, on remote power sources, such as batteries, for extended use.

As already mentioned, the present invention provides different combinations of night vision products that can either be arranged to be worn on the head, hand-held, or born on remotely operated vehicles. The various products share common elements but differ in the way they are supported as a user looks through them under low light level conditions. In general, the apparatus comprises a solid state imager sensitive to infrared radiation, a source for generating infrared radiation within the spectral response range of the solid state imager and directing this radiation into the field of view of the imager, and an image generator that receives the output from the imager and generates a visible image representative of the output of the image at a position visible to the person wearing the apparatus. Thus, in contrast to passive military night vision apparatus, the apparatus of the present invention is an “active” apparatus which generates the infrared radiation used to form the image. Since the scene being viewed by the user is being “illuminated” (in the infrared) by the apparatus itself, the apparatus of the present invention can use a solid state imager much less sensitive, and much less costly, than the image intensifier tube arrangements used in military night vision apparatus. The preferred form of solid state imager for use in the present invention is a complementary metal oxide semiconductors (CMOS) device, although other solid state imagers may also be used.

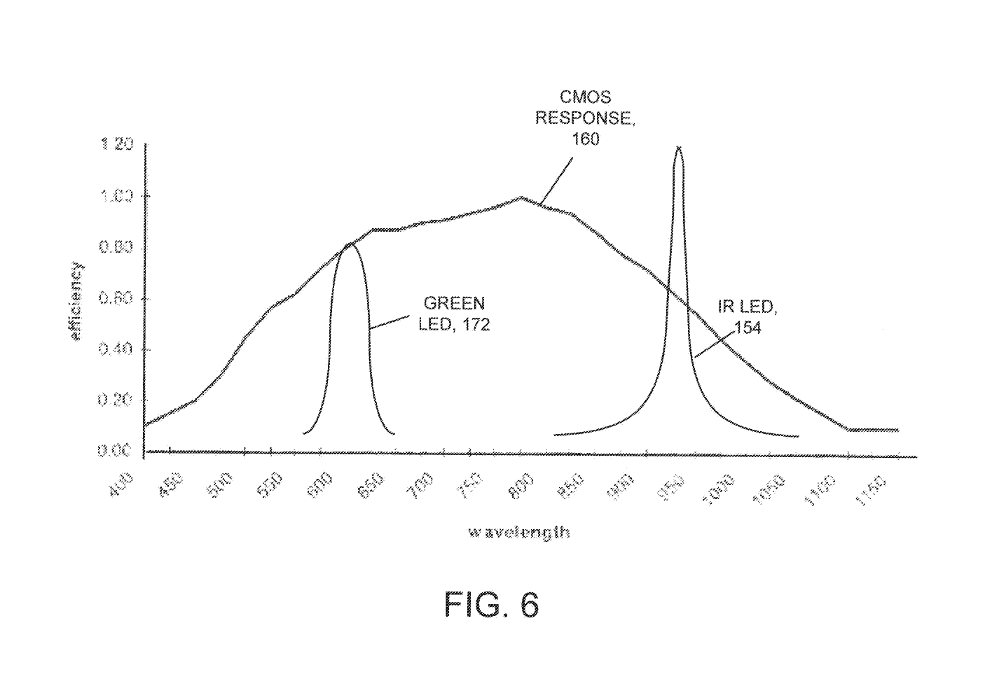

As discussed in more detail below with regard to FIG. 6, CMOS imagers are usually sensitive to infrared radiation only in the range of about 700 to 1000 (or in some case 1050-1075) nm. CMOS sensors are, of course, also sensitive to visible radiation of 400 to 700 nm, and in the present apparatus there is no particular reason to exclude visible light from the imager, i.e., the imager can be allowed to form an image using both the infrared radiation reflected from the scene viewed and any available ambient visible light. If a CMOS sensor is used in the present apparatus, the infrared radiation source is chosen to generate infrared radiation within the range of about 700 to 1000 nm to which the imager is particularly sensitive. Fortunately, inexpensive infrared radiation emitting diodes operating within this range are readily available commercially and are inexpensive. Operating in the 700 to 1000 nm range also has the advantage that the images generated using such near infrared radiation are much more similar to visible images than images formed using far infrared radiation with wavelengths of 2000 nm or more, and hence are easier for inexperienced users to interpret.

The operation of the various night vision modules may best be understood by explaining how they are used in connection with the Night Vision Goggles shown in FIGS. 1a and 1b.

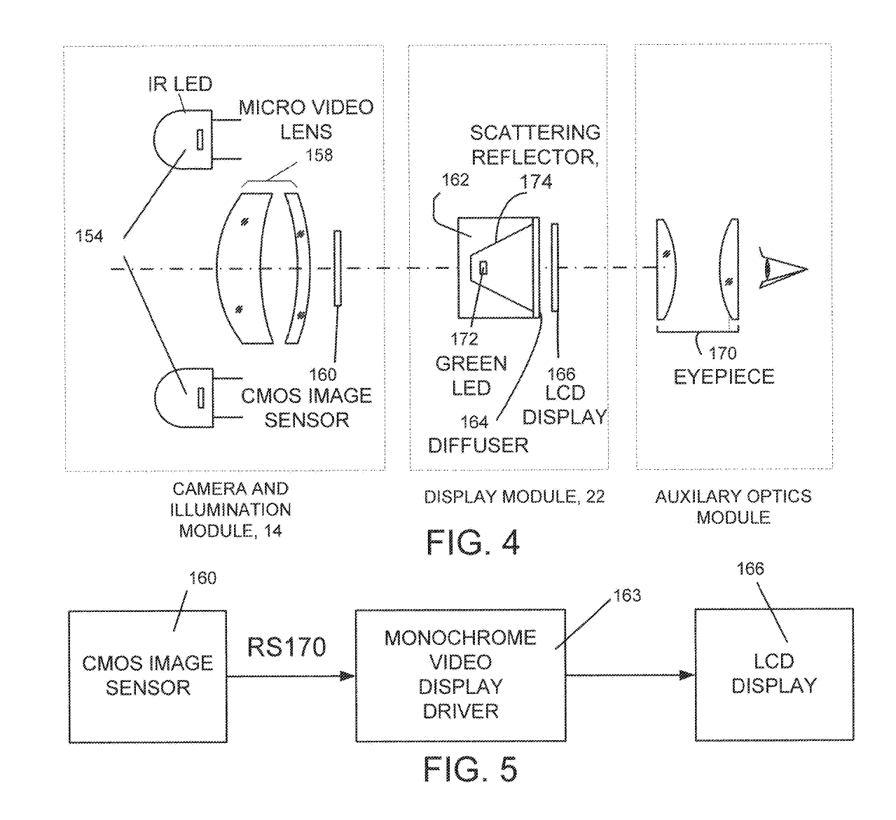

Referring now to FIGS. 1A and 1B, there is shown a preferred night vision, head-worn system generally designated as 16 in FIG. 1B. As best seen in FIG. 4, system 16 has three modules that releasably attach to head mount 10. Head mount 10 is worn on the head of the user and may be powered by a battery pack worn at the waist of the user by attachment with a clip to the user's belt. A connecting cable extending from the battery pack to the head mounted system 16 may be used for supplying electric power to the electrical components of the head mounted system 16.

The head mount 10 is worn on the head of the user in a manner substantially similar to that of a pair of ski goggles, or the like, with an upper section 13 extending across the brow, and the camera and illumination module 14 supported beneath the upper section 13 and extending downwardly to be centrally located between the user's eyes. The head mounted system 16 provides monocular night vision for at least one eye. It should be noted that the head mounted system 16 preferably is designed so that at least one eye can observe surrounding features through a window that is at least partially clear. This is a safety feature. Because the field of view of a typical solid state image sensor is rather narrow, the night vision image lacks peripheral vision. Therefore, the eye not used to observe can be used to see surrounding features using available light. Peripheral vision is important in avoiding obstacles and ensuring that a person walking does not accidentally fall over sudden drops, which may lie off to one side of the user's path. Since the apparatus of the present invention will typically be used in situations where there is at least some visible light present, keeping one eye of the user unobstructed allows the user to have at least some peripheral vision and thus helps to avoid collisions with obstacles and accidents due to falls etc.

Any battery pack used is of substantially conventional design, having a main body that is hollow to provide a large cavity into which may be inserted four 1.5 V batteries (AAs). A cover member may be releasably secured to the main body by means of a screw or snap to hold the batteries in place within the main body. The main body may also be provided with an electrical receptacle into which a plug, secured to one end of a cable, fits.

The head mounted system 16 attaches to the users head via elastic strap 12 that may be adjusted for head size and is adapted in well-known manners to have the various night vision modules releasably attached to it so that they can easily be removed for use with other base units.

The camera and illumination module 14 as best seen in FIGS. 4 and 5 comprises a centrally located micro video lens 158 surrounded by a circular pattern of IR LEDs 154. Behind the micro video lens 158 is located a CMOS image sensor 160. The LEDs 154 used in camera and illumination module 14 are preferably of two different types, one having a narrow field of emission and the other having a substantially wider field of emission, with the two types alternating around the circular pattern. It has been found that this arrangement of narrow angle and wide angle diodes provides optimal illumination of the entire field of view of the image sensor 160, the narrow angle diodes illuminating more distant objects while the wide angle diodes the closer objects. However, it will be recognized that one or the other can be used or used in different geometries and quantities consistent with the need to minimize the power consumption of the unit and hence the drain on the batteries.

A red filter may be mounted forward of the LEDs 154 to pass infrared and visible radiation having wavelengths greater than about 650 nm.

The other optical and image-forming components are as follows:

(a) the micro video lens 158 which extends through a central aperture along the optical axis, gathers infrared and visible radiation, and images this radiation on to

(b) the CMOS sensor 160 mounted along the optical axis in the camera and illumination module 14;

(c) the display module 22 comprising a back-lighting unit 162 having the form of a green light-emitting diode (see below with reference to FIG. 6) combined with a scattering reflector 174;

(d) a diffuser 164 disposed adjacent the back-lighting unit 162 to diffuse light emitted from the back-lighting unit;

(e) a liquid crystal display 166 disposed adjacent the diffuser 164 so as to be backlit by light passing therethrough;

(f) an auxiliary optics module comprising an eyepiece assembly 170 arranged to form an image of the display 166 immediately in front of the right eye of the user. It should be noted that the auxiliary optics module need not be used in the other combinations where the eye can accommodate the image which would be located at a normal viewing distance.

The mode of operation of the optical and imaging components 158-170 of the invention will now be explained with reference to FIGS. 4 and 5. As shown schematically in FIG. 4, the infrared LEDs 154 emit infrared radiation that passes through a filter (not shown), is reflected from objects in front of the user, passes back through a centrally located aperture, and is imaged by the two-element micro video lens 158 on the CMOS sensor 160. As shown in FIG. 5, the sensor 160 generates a standard RS170 video output signal that is fed to a monochrome video display driver 163. The output from driver 163 is fed to the liquid crystal display 166.

Returning to FIG. 4, it will be seen that the back-lighting unit 162 comprises a green LED 172 lying within a frusto-conical cavity in a scattering reflector 174, the diffuser 164 lying across the wide end of the frusto-conical cavity. A green diode is chosen because this is the color to which the human eye is most sensitive, and hence which minimizes light output and power consumption for an image of any desired intensity. The combination of the scattering reflector 174 and the diffuser 164 provides a substantially uniform distribution of green light across the diffuser 164 and hence substantially uniform back-lighting of the display 166 disposed adjacent the diffuser 164. Green light passing through the display 166 is imaged by the two-element eyepiece assembly 170 of the auxiliary optics module to form an image visible to the eye of the user.

The arrangement of optical and imaging components shown in FIGS. 4 and 5, in which the sensor 160 and the display 166 are substantially aligned along a common axis, provides an extremely compact and convenient form factor. The arrangement is also designed to avoid two potential problems. As shown in FIG. 6, the infrared diodes 154 emit at around 850 nm, the green diode 172 emits around 575 nm, and the sensor 160 has substantial sensitivity over the range of about 475 to about 1075 nm. Accordingly, it is necessary to arrange the optical system so that no light from green diode 172 can reach the sensor 160, since the sensor would be affected by the green light and the desired infrared image would be degraded. The arrangement of the green diode 172 within the frusto-conical cavity of the reflector 174 and the mounting of the sensor 160 immediately adjacent the “back” surface of the reflector 174 (i.e., the surface facing away from the diffuser 164) prevent light from the green diode 172 reaching the sensor 160. Also, for reasons already noted, it is undesirable for a night vision system to emit any visible light, and proper filtering assures that any light from the green diode 172, which may be reflected forwardly (i.e., away from the user), for example by reflection from the display 166, will not emerge from this module.

The preferred apparatus of the present invention shown in the accompanying drawings is simple, compact and can readily be manufactured using inexpensive, commercially available components. For example, the monochrome display driver can be a Motorola MCVVQ111 VirtuoVue driver, while the display 166 can be a Cyberdisplay 320 display, available from Kopin Corporation of Taunton Mass., with a 320×240 pixel output. The sensor 160 can be an OmniVision OV5116N CMOS sensor available from OmniVision Technologies, Inc., of Sunnyvale Calif., while the infrared diodes 154 can be Model RT-7507ET from Rodan (Taiwan) Ltd., and the green diode 174 can be a Kingbright Model AA3528 surface mount LED lamp. Using such components, bright images within the range from about 30 to 100 feet can be readily seen.

It will readily be apparent to those skilled in the art that numerous changes and modifications can be made to the preferred embodiments of the invention described above without departing from the scope of the invention. For example, the CMOS sensor 160 could be replaced by another type of solid state imager, for example a charged coupled device (CCD). A color camera that also has extended infrared sensitivity could be used in conjunction with a color display to provide a color rendition of the visible scene. Higher resolution (high-definition) imager and displays could be used with associated higher costs. Also, the monocular embodiment described could be modified to a binocular model which forms images in front of both eyes of the user, although in this case it would be desirable to arrange for the image forming and display assemblies to be mounted on the head of the user so that they can be swiveled upwardly when not in use, since for reasons already explained, it is undesirable for inexperienced users to walk around looking only through night vision apparatus. Therefore, it is intended that the embodiments described herein be considered as illustrative and not be construed in a limiting sense. From the foregoing, it will be seen that the present invention provides a night vision apparatus that is adaptable, inexpensive, compact, robust and well suited for use by the general public, and which does not emit visible radiation permitting observations that can be made at night without notice by or disturbing animals.

Other embodiments of the invention will be apparent from its teachings, and such variants are intended to be within the scope of the appended claims.

What is claimed is:

1. An adaptable modular night vision system, said system comprising:
a plurality of individual night vision function providing modules that are adapted to selectively releasably interface with others in the system so that, when mated, each combination provides a product whose features are not available with the individual modules themselves, said night vision function providing modules comprising a camera and illumination module, a separate illumination and camera module, a display module, an auxiliary optics module for observing displayed images when close to the naked eye, and a communication link module; and
a plurality of base modules including a head mounted base module, a hand held base module, and at least one vehicle base module,
said night vision function providing modules and said base modules each having common interfaces to permit their combination to form a head mount night vision device, a hand held night vision device, a remote camera device, a vehicle, and a hand held vehicle controller.

2. The adaptable night vision system of claim 1 wherein said camera and illumination module comprises:
a solid state imager having an operating mode having substantial sensitivity to infrared radiation and having an image output signal, said solid state imager having a field of view; and
a radiation source to generate infrared radiation and to direct such radiation into said field of view of said solid state imager.

3. The adaptable night vision system of claim 2 wherein said display module is arranged to receive said image output signal from said solid state imager and to generate a visible image representative of said image visible to a user.

4. The adaptable night vision system of claim 1 wherein said solid state imager is a complementary metal oxide semiconductor device.

5. The adaptable night vision system of claim 1 wherein said solid state imager is sensitive to infrared radiation in the range of about 700 to about 1000 nm.

6. The adaptable night vision system of claim 1 wherein said solid state imager is also sensitive to visible radiation in the range of about 400 to about 700 nm.

7. The adaptable night vision system of claim 1 wherein said infrared radiation source comprises at least one infrared radiation emitting diode.

8. The adaptable night vision system of claim 7 wherein said infrared radiation source comprises at least two infrared light emitting diodes, at least one of said diodes being arranged to illuminate a wide area of said field of view of the solid state imager and at least one of said diodes being arranged to illuminate a narrower area adjacent the center of said field of view.

9. The adaptable night vision system of claim 1 further comprising a lens arranged to collect infrared radiation and to focus said radiation on said solid state imager, and wherein said infrared radiation source comprises at least three radiation emitting diodes arranged on a circle surrounding said lens.

10. The adaptable night vision system of claim 1 wherein said image display comprises a backlit liquid crystal display.

11. The adaptable night vision system of claim 1 wherein said liquid crystal display is mounted between said solid state imager and said user so that the backlight of said liquid crystal display is not visible except to a user.

12. The adaptable night vision system of claim 11 wherein the backlight of said liquid crystal display is provided by a light emitting diode and a diffuser is provided to diffuse the light from said diode across said liquid crystal display.

13. The adaptable night vision system of claim 12 wherein said light emitting diode emits green light.

14. The adaptable night vision system of claim 1 wherein said auxiliary optics module comprises an eyepiece lens for focusing on adjacent said liquid crystal display, said eyepiece lens lying between said liquid crystal display and the eye of a user.

15. The adaptable night vision system of claim 1 wherein head mounted base module comprises a head mount configured to permit it to be worn on a user's head so that an image is visible to a user.

17. The adaptable night vision system of claim 1 wherein said toy vehicle is selected from the group comprising remote controlled vehicle including an RC car, boat, plane, and helicopter.

18. The adaptable night vision system of claim 1 wherein said communication link module is present in at least one of said base modules and said night vision function providing modules.

19. The adaptable night vision system of claim 18 wherein said communication link modules is selected from the group comprising direct wiring, a wireless link including Bluetooth®, analog radio frequency signals, digital radio signals, and an infrared optical link.
